(19) United States
(12) Patent Application Publication
(10) Pub. No.: US 2007/0075633 A1
(43) Pub. Date: Apr. 5, 2007

(54) ORGANIC ELECTROLUMINESCENCE DEVICE AND ELECTRONIC APPARATUS

(75) Inventor: Koji YASUKAWA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/531,874

(22) Filed: Sep. 14, 2006

(30) Foreign Application Priority Data
Sep. 30, 2005 (JP) 2005-286413

(51) Int. Cl. H01J 1/62; H01J 63/04

(52) U.S. Cl. 313/504

(57) ABSTRACT

There is provided an organic electroluminescence device including: a pixel electrode which is formed on a substrate in an island shape; a functional layer which covers the surface of the pixel electrode; and an opposing electrode which is laminated on the functional layer, wherein a taper angle between the side surface of the pixel electrode and the surface of the substrate is 20° or less.

### BACKGROUND

1. Technical Field

The present invention relates to an organic electroluminescence device (hereinafter, referred to as an organic EL device) and an electronic apparatus.

2. Related Art

An organic EL device, as shown in FIG. 6, includes a pixel electrode 11 which is formed on a substrate 10 in an island shape as an anode, a functional layer 13 which covers the surface of the pixel electrode 11, and an opposing electrode which is laminated on the functional layer 13 as a cathode 14. The functional layer 13 functions as a light-emitting layer for performing a light-emitting function. Since the functional layer 13 is prone to deterioration by moisture, a cathode cover layer 15 and a resin layer 16 are generally laminated on the cathode 14. In the organic EL device having the above-described configuration, the thicknesses of the layers and the taper angle α between the side surface of the pixel electrode 11 and the surface of the substrate, for example, satisfy the following conditions

pixel electrode 11: 100 nm

functional layer 13: 100 nm

cathode 14: 10 nm

cathode cover layer 15: 200 nm

resin layer 16: 3000 nm

taper angle: 80°.

When a step difference is formed on the substrate by the pixel electrode, step disconnection occurs in the functional layer. Accordingly, as an organic EL device having a different configuration, a configuration in which the side surface of the pixel electrode is a tapered surface and a configuration in which another metal film is formed on the side surface of the pixel electrode has been disclosed (for example, JP-A-10-294183).

However, the configuration disclosed in JP-A-10-294183 is used to prevent the step disconnection from occurring in the functional layer and cannot solve the following problems. That is, when a moisture resistance test for the organic EL device is performed, excessive stress is applied to the cathode 14 to form a crack and moisture reaches the functional layer 13 through the crack. The moisture deteriorates the functional layer 13 to cause a pixel shrinkage phenomenon in which the light emission area of a pixel is reduced.

As a result of the present inventors examining such a problem, it has been found that the stress which forms the crack in the cathode 14 is influenced by the step difference formed by the end of the pixel electrode 11. However, even if the thicknesses of the layers shown in FIG. 6 and the taper angle α between the side surface of the pixel electrode 11 and the surface of the substrate, for example, satisfy the following conditions

pixel electrode 11: 100 nm

functional layer 13: 100 nm

cathode 14: 10 nm

cathode cover layer 15: 200 nm

resin layer 16: 3000 nm

taper angle: 450°,

it is found that it is impossible to prevent with certainty the crack from forming in the cathode 14.

### SUMMARY

An advantage of some aspects of the invention is the provision of an organic EL device and an electronic apparatus using the same, which is capable of preventing a crack from forming in an opposing electrode formed on a functional layer and preventing the functional layer from deteriorating due to moisture.

According to an aspect of the invention, there is provided an organic electroluminescence device including: a pixel electrode which is formed on a substrate in an island shape; a functional layer which covers a surface of the pixel electrode; and an opposing electrode which is laminated on the functional layer, wherein the taper angle between a side surface of the pixel electrode and the surface of the substrate is 20° or less.

In the invention, since the taper angle between the side surface of the pixel electrode and the surface of the substrate is 20° or less, although the step difference is formed in the functional layer or the opposing electrode by the step difference of the end of the pixel electrode, the step difference is small. Although a moisture resistance test for the organic EL device is performed, excessive stress is not applied to the opposing electrode and thus crack is not formed in the opposing electrode. Accordingly, since moisture does not penetrate into the functional layer through the crack formed in the opposing electrode, it is possible to prevent the functional layer from deteriorating due to the moisture. Accordingly, it is possible to prevent with certainty a light emission area from being reduced due to the deterioration of the functional layer.

It is preferable that the thickness of the pixel electrode is 50 nm or less. By this configuration, although the step difference is formed in the functional layer or the opposing electrode, the step difference is small. Although a moisture resistance test for the organic EL device is performed, excessive stress is not applied to the opposing electrode. Thus, it is possible to prevent with certainty crack from forming in the opposing electrode.

According to another aspect of the invention, there is provided an organic electroluminescence device including: a pixel electrode which is formed on a substrate in an island shape; a functional layer which covers a surface of the pixel electrode; and an opposing electrode which is laminated on the functional layer, wherein the thickness of the pixel electrode is 50 nm or less.

In the invention, since the thickness of the pixel electrode is 50 nm or less, although the step difference is formed in the functional layer or the opposing electrode by the step difference of the end of the pixel electrode, the step difference is small. Although a moisture resistance test for the organic EL device is performed, excessive stress is not applied to the opposing electrode and thus crack is not formed in the opposing electrode. Accordingly, since moisture does not penetrate into the functional layer through the crack formed in the opposing electrode, it is possible to prevent the functional layer from deteriorating due to the moisture. Accordingly, it is possible to prevent with certainty a light emission area from being reduced due to the deterioration of the functional layer.

The organic EL device according to the invention is used in electronic apparatuses such as various display devices, copiers and image forming apparatuses.

### BRIEF DESCRIPTION OF THE DRAWINGS

The invention will be described with reference to the accompanying drawings, wherein like numbers reference like elements.

FIG. 1 is a block diagram showing an electrical configuration of an organic EL device according to the invention.

FIG. 2 is a cross-sectional view of an organic EL device according to a first embodiment of the invention.

FIGS. 3A to 3C are views showing methods of forming a pixel electrode having a small taper angle when manufacturing the organic EL device according to the first embodiment of the invention.

FIG. 4 is a cross-sectional view of an organic EL device according to a third embodiment of the invention.

FIGS. 5A to 5C are views showing electronic apparatuses each including the organic EL device according to the invention.

FIG. 6 is a cross-sectional view of an organic EL device of a related art.

### DESCRIPTION OF EXEMPLARY EMBODIMENTS

Hereinafter, embodiments of the invention will be described with reference to the accompanying drawings.

### First Embodiment

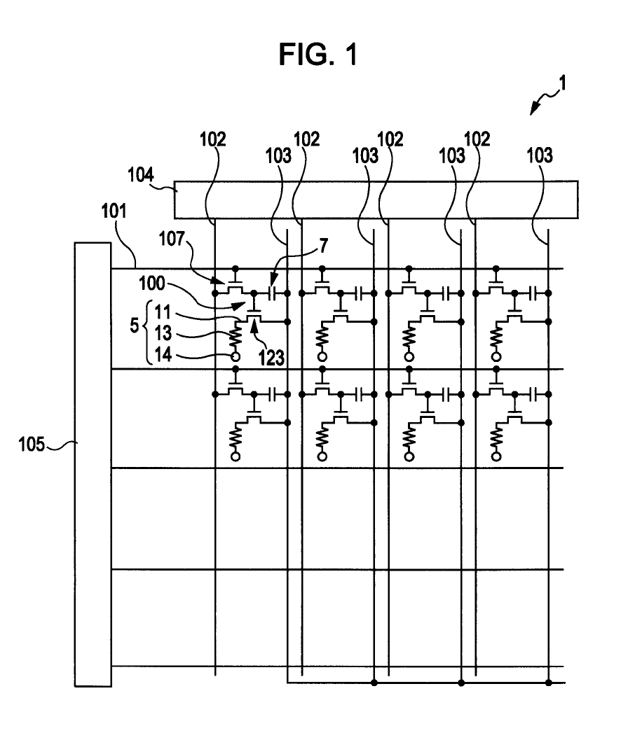

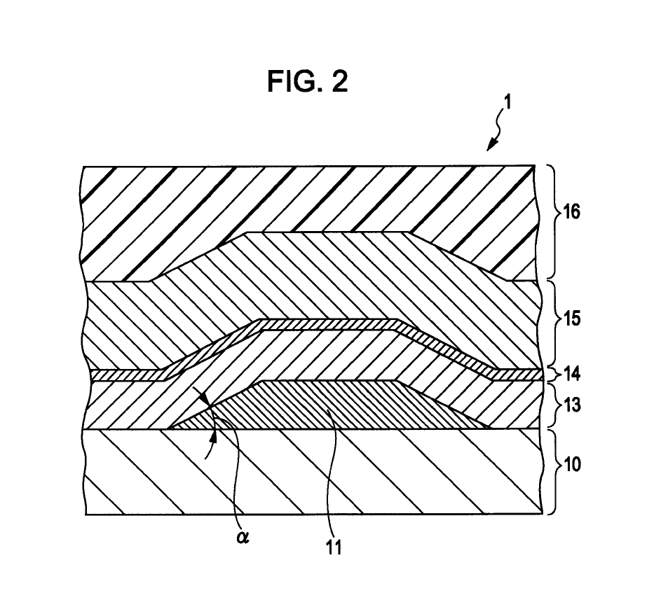

FIG. 1 is a block diagram showing an electrical configuration of an active-matrix-type organic EL display device according to the invention. FIG. 2 is a cross-sectional view of one pixel formed in the organic EL device according to a first embodiment of the invention.

As shown in FIG. 1, the organic EL device 1 includes a plurality of scanning lines 101, a plurality of signal lines 102 which extend in a direction perpendicular to the scanning lines 101, a plurality of power supply lines 103 which extend parallel to the signal lines 102, and pixel regions 100 which are formed in the vicinities of intersections between the scanning lines 101 and the signal lines 102. The signal lines 102 are connected to a data side driving circuit 104 having a shift register, a level shifter, a video line and an analog switch, and the scanning lines 101 are connected to a scanning side driving circuit 105 having a shift register and a level shifter. In each of the pixel regions 100, a switching thin-film transistor 107 of which the gate electrode is supplied with a scanning signal through the scanning line 101, a holding capacitor 7 which holds a pixel signal supplied from the signal line 102 through the switching thin-film transistor 107, a driving thin-film transistor 123 of which the gate electrode is supplied with the pixel signal held by the holding capacitor 7, a pixel electrode 11 (anode) into which driving current flows from the power supply line 103 when being connected to the power supply line 103 through the driving thin-film transistor 123, and a functional layer 13 which is interposed between the pixel electrode 11 and the cathode 14 (opposing electrode). Here, the pixel electrode 11, the functional layer 13 and the cathode 14 configure an organic EL element 5.

Each pixel of the organic EL device 1, as shown in FIG. 2, includes the pixel electrode 11 which is formed on a substrate 10 in an island shape and formed of an indium-tin oxide (ITO) film, the functional layer 13 which covers the surface of the pixel electrode 11, and the cathode 14 which is laminated on the functional layer 13 and formed of magnesium-silver alloy. The functional layer 13 has at least a light-emitting layer. The functional layer 13 may further have a hole injection layer or a hole transport layer disposed below the light-emitting layer. In any case, since the functional layer 13 is formed of a low-molecular-weight organic material such as a derivative of stilbene series, carbazole series, hydrazone series, arylamine series, oxadiazole series or starburst series, the functional layer 13 is prone to deterioration due to moisture. Accordingly, in the present embodiment, a cathode cover layer 15 made of an inorganic material such as a silicon oxide film, a silicon nitride film or a silicon oxynitride film and a resin layer 16 made of epoxy resin are laminated on the cathode 14. Although a thin-film transistor or an optical resonator is formed on the surface of the substrate 10 and the pixel electrode 11 is formed thereon, in the following description, the thin-film transistor or the optical resonator is omitted.

In the organic EL device 1 having the above-described configuration, the thicknesses of the layers and the taper angle α between the side surface of the pixel electrode 11 and the surface of the substrate, for example, satisfy the following conditions

pixel electrode 11: 100 nm

functional layer 13: 100 nm

cathode 14: 10 nm

cathode cover layer 15: 200 nm

resin layer 16: 3000 nm

taper angle: 20°.

That is, in the present embodiment, although the thickness of the pixel electrode 11 is 100 nm, similar to that of the known pixel electrode, the taper angle α between the side surface of the pixel electrode 11 and the surface of the substrate is set to 20° or less.

According to the present embodiment, although step differences are formed in the functional layer 13, the cathode 14, the cathode cover layer 15 and the resin layer 16 due to the step difference formed in the side surface of the pixel electrode 11, the step differences are small. As a result of a moisture resistance test for the organic EL device 1 being performed, excessive stress is not applied to the cathode 14 and thus a crack is not formed in the cathode 14. Accordingly, since moisture does not penetrate into the functional layer 13 through the crack formed in the cathode 14, it is possible to prevent the functional layer 13 from deteriorating due to the moisture. Accordingly, it is possible to prevent with certainty the light emission area from being reduced due to the deterioration of the functional layer 13.

When an organic EL device of which the taper angle α between the side surface of the pixel electrode 11 and the surface of the substrate is set to 20° or less, an organic EL device of which the taper angle α between the side surface of the pixel electrode 11 and the surface of the substrate is set to 45° and an organic EL device of which the taper angle α between the side surface of the pixel electrode 11 and the surface of the substrate is set to 80° are left in an atmosphere having a temperature of 60° C. and a relative humidity of 95%, the relationship between the taper angle α and the shrinkage degree of the light emission area is as follows:

taper angle α=20°: shrinkage degree of the light emission area=10%

taper angle α=45°: shrinkage degree of the light emission area=40%

taper angle α=80°: shrinkage degree of the light emission area=60%

That is, in an organic EL device according to the present embodiment, it can be seen that the light emission area is reduced by at most 10%.

Manufacturing Method

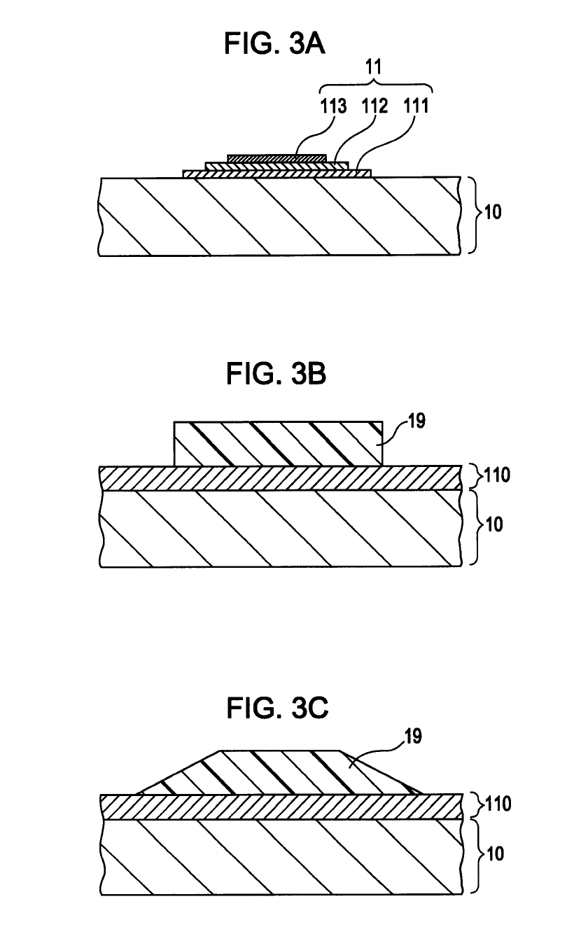

When the organic EL device 1 is manufactured, in order to set the taper angle α between the side surface of the pixel electrode 11 and the surface of the substrate to 20° or less, for example, methods shown in FIGS. 3A to 3C may be employed. FIGS. 3A to 3C are views showing methods of forming the pixel electrode 11 having a small taper angle α.

As shown in FIG. 3A, when the pixel electrode 11 is formed, an ITO film is formed and patterned several times to form a plurality of ITO films 111, 112 and 113. At this time, it is preferable that the sizes of the ITO films gradually decrease from bottom to top. Accordingly, it is possible to form the pixel electrode 11 having a small taper angle α.

As shown in FIG. 3B, the ITO film 110 is formed on the substrate 10, a resist mask 19 is formed thereon, and wet etching is performed in a state that the adhesion between the ITO film 110 and the resist mask 19, for example, the adhesion between the substrate 10 and the ITO film 110, is decreased. Since side etching is performed in the interface between the ITO film 110 and the resist mask 19 at the time of wet etching, it is possible to form the pixel electrode 11 having a small taper angle α.

As shown in FIG. 3C, the ITO film 110 is formed on the substrate 10, the resist mask 19 having a taper at its end is formed, and dry etching is performed using gas containing oxygen. Since the ITO film 110 and the resist mask 19 are simultaneously etched, it is possible to form the pixel electrode 11 having a small taper angle α.

After the pixel electrode 11 is formed, the functional layer 13, the cathode 14, the cathode cover layer 15 and the resin layer 16 are sequentially formed using a vacuum deposition method, a sputtering method, an ion plating method or a spin-coating method.

### Second Embodiment

In an organic EL device according to a second embodiment of the invention, the thicknesses of the pixel electrode 11, the functional layer 13, the cathode 14, the cathode cover layer 15 and the resin layer 16 described with reference to FIG. 2 and the taper angle α between the side surface of the pixel electrode 11 and the surface of the substrate, for example, satisfy the following conditions

pixel electrode 11: 200 nm

functional layer 13: 100 nm

cathode 14: 10 nm

cathode cover layer 15: 200 nm

resin layer 16: 3000 nm

taper angle: 20°.

That is, in the present embodiment, the thickness of the pixel electrode 11 is 200 nm, which is twice as large as that of the known pixel electrode, and the taper angle α between the side surface of the pixel electrode 11 and the surface of the substrate is set to 20° or less.

According to the present embodiment, although the step differences are formed in the functional layer 13, the cathode 14, the cathode cover layer 15 and the resin layer 16 due to the step difference formed in the side surface of the pixel electrode 11, the step differences are small. Although a moisture resistance test for the organic EL device 1 is performed, excessive stress is not applied to the cathode 14 and thus crack is not formed in the cathode 14. Accordingly, since moisture does not penetrate into the functional layer 13 through the crack formed in the cathode 14, it is possible to prevent the functional layer 13 from deteriorating due to the moisture. Accordingly, it is possible to prevent with certainty the light emission area from being reduced due to the deterioration of the functional layer 13. Even when the organic EL device according to the present embodiment is left in an atmosphere having a temperature of 60° C. and a relative humidity of 95%, it can be seen that the light emission area is reduced by at most 10%.

### Third Embodiment

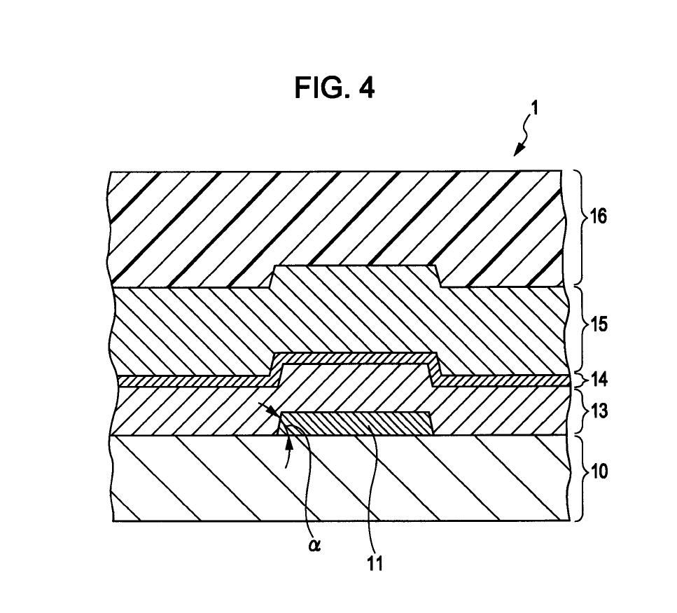

FIG. 4 is a cross-sectional view of one pixel formed in an organic EL device according to a third embodiment of the invention. As shown in FIG. 4, the organic EL device according to the present embodiment includes the pixel electrode 11 which is formed on a substrate 10 and formed of the indium-tin oxide (ITO) film, the functional layer 13 which covers the surface of the pixel electrode 11, and the cathode 14 which is laminated on the functional layer 13 and formed of magnesium-silver alloy. The cathode cover layer 15 made of a silicon oxynitride film or the like and the resin layer 16 made of epoxy resin are laminated on the cathode 14.

In the organic EL device 1 having the above-described configuration, the thicknesses of the layers and the taper angle α between the side surface of the pixel electrode 11 and the surface of the substrate, for example, satisfy the following conditions

pixel electrode 11: 50 nm

functional layer 13: 100 nm

cathode 14: 10 nm

cathode cover layer 15: 200 nm

resin layer 16: 3000 nm

taper angle: 80°.

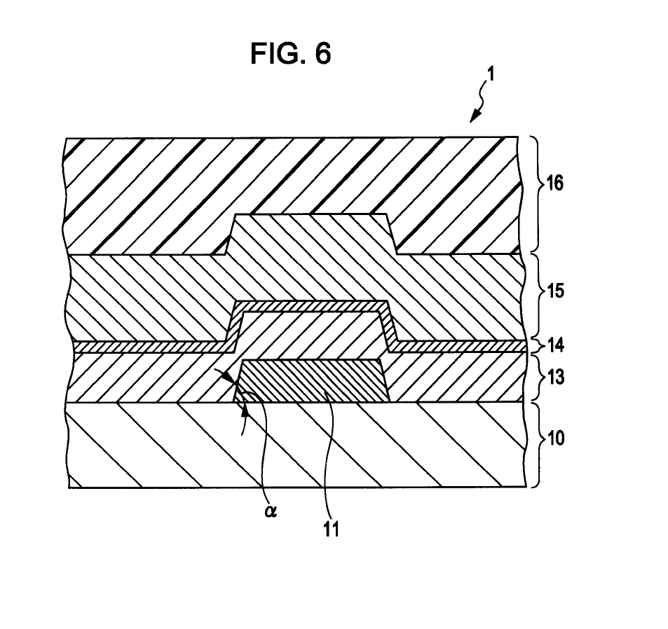

That is, in the present embodiment, although the taper angle α between the side surface of the pixel electrode 11 and the surface of the substrate is set to 80°, similar to the configuration shown in FIG. 6, the thickness of the pixel electrode 11 is 50 nm, which is a half of the known pixel electrode.

According to the present embodiment, although the step differences are formed in the functional layer 13, the cathode 14, the cathode cover layer 15 and the resin layer 16 due to the step difference formed in the side surface of the pixel electrode 11, the step differences are small. Although a moisture resistance test for the organic EL device 1 is performed, excessive stress is not applied to the cathode 14 and thus crack is not formed in the cathode 14. Accordingly, since moisture does not penetrate into the functional layer 13 through the crack formed in the cathode 14, it is possible to prevent the functional layer 13 from deteriorating due to the moisture. Accordingly, it is possible to prevent with certainty the light emission area from being reduced due to the deterioration of the functional layer 13. Even when the organic EL device according to the present embodiment is left in an atmosphere of 60° C. and a relative humidity of 95%, it can be seen that the light emission area is reduced by at most 10%.

### Other Embodiments

The invention is not limited to the aforementioned embodiments and may be changed without departing the spirit of the invention. For example, although the thickness of the pixel electrode 11 is 100 nm in the first embodiment, the thickness of the pixel electrode 11 may be 50 nm, similar to the third embodiment.

In the aforementioned embodiments, since the functional layer is formed of the low-molecular-weight material, the vacuum deposition method is employed in the manufacturing method. A high molecular material may be used to form the functional layer and the functional layer may be formed by mixing the high molecular material to a solvent and discharging the solvent using an inkjet method. Application of Organic EL Device to Electronic Apparatus

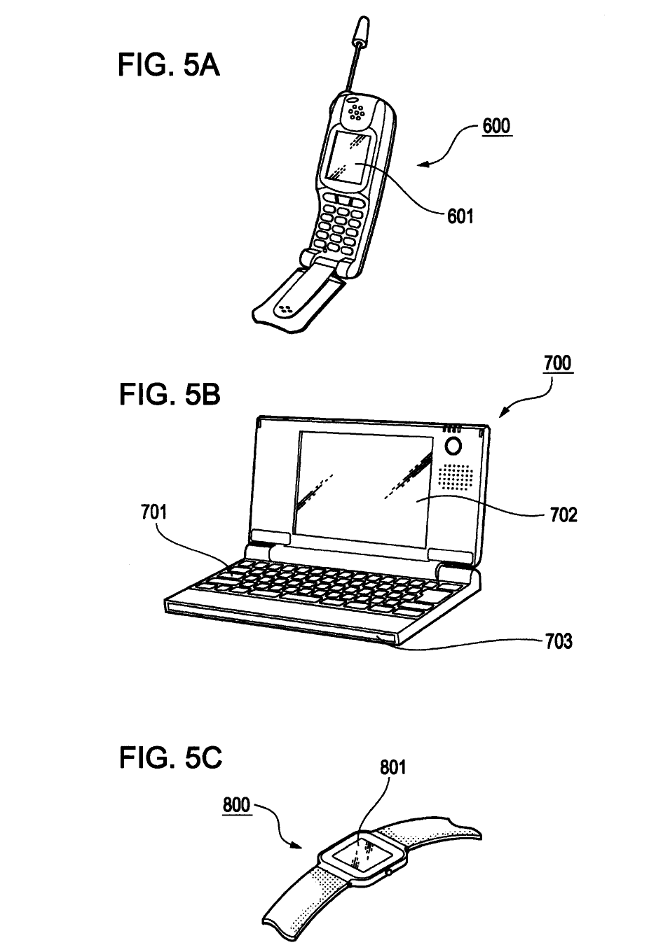

An electronic apparatus including the organic EL device according to the invention will be described. FIG. 5A is a perspective view showing an example of a mobile telephone. In FIG. 5A, a reference numeral 600 denotes a main body of the mobile telephone and 601 denotes a display unit using the organic EL device. FIG. 5B is a perspective view showing an example of a portable information processing apparatus such as a word processor or a personal computer (PC). In FIG. 5B, a reference numeral 700 denotes an information processing apparatus, 701 denotes an input unit such as a keyboard, 703 denotes an main body of the information process apparatus, and 702 denotes a display unit using the organic EL device. FIG. 5C is a perspective view showing an example of a wristwatch type electronic apparatus. In FIG. 5C, a reference numeral 800 denotes a watch body and 801 denotes a display unit using the organic EL device.

What is claimed is:

1. An organic electroluminescence device comprising:
a pixel electrode which is formed on a substrate in an island shape;
a functional layer which covers a surface of the pixel electrode; and
an opposing electrode which is laminated on the functional layer,
wherein a taper angle between a side surface of the pixel electrode and the surface of the substrate is 20° or less.

2. An organic electroluminescence device comprising:
a pixel electrode which is formed on a substrate in an island shape;
a functional layer which covers a surface of the pixel electrode; and
an opposing electrode which is laminated on the functional layer,
wherein the thickness of the pixel electrode is 50 nm or less.

3. The organic electroluminescence device according to claim 1, wherein the thickness of the pixel electrode is 50 nm or less.

4. An electronic apparatus comprising the organic electroluminescence device according to claim 1.
